(19) United States
(12) Patent Application Publication
(10) Pub. No.: US 2004/0266929 A1
(43) Pub. Date: Dec. 30, 2004

(54) Solid adhesive and liquid material composition for producing the solid adhesive

(76) Inventors: Daisuke Imai, Suita-shi (JP); Akio Naka, Suita-shi (JP); Kazuhiro Okamura, Sanda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/853,154

(22) Filed: May 26, 2004

(30) Foreign Application Priority Data
May 27, 2003 (JP) 2003-148907(PAT.)

(51) Int. Cl. C08K 3/30

(52) U.S. Cl. 524/418

(57) ABSTRACT

A solid adhesive comprising a water-soluble adhesive polymer and a polymer component derived from an aqueous polymer emulsion as the components, wherein a solid content of the aqueous polymer emulsion are contained in an amount of 0.01 to 30 mass % with respect to the total amount of the water-soluble adhesive polymer and the solid content of aqueous polymer emulsion.

### BACKGROUND OF THE INVENTION

1. Field of the Invention

The present invention relates to a solid adhesive excellent in adhesiveness and coatability on substrates and a liquid material composition for producing the solid adhesive.

2. Description of the Related Art

There have been known so-called adhesive sticks produced by filling a solid adhesive, containing a water-soluble adhesive polymer such as polyvinylpyrrolidone (PVP) or the like as the principal component and a gelling agent for shape preservation such as a long-chain fatty acid salt, into a lipstick-shaped container.

These solid adhesives demand a superior initial adhesiveness. In other words, when the adhesive is coated on one of a pair of substrates and the adhesive-coated substrate is bonded to another substrate, the period required for the adhesive to exert its adhesive strength should be shorter to some degree. Various improvements have been made for that purpose.

For example, for improvement in the initial adhesiveness of solid adhesives, a method by using a water-soluble polymer such as PVP or the like together with an emulsion substance (aqueous polymer emulsion) was proposed in Japanese Unexamined Patent Publication No. 54-34342. According to this patent application, the initial adhesiveness of solid adhesives is raised by using a great amount of an aqueous polymer emulsion.

However, studies by the present inventors revealed that increase in the amount of solid content in the aqueous polymer emulsion with respect to the total amount of the water-soluble polymer and the solid content (polymer particles) in the aqueous polymer emulsion lead to decrease in the hardness of the resulting solid adhesive, consequently leading to deterioration in shape stability and thus in coatability onto substrates. According to the method described in Japanese Unexamined Patent Publication No. 54-34342, a gelling agent (long-chain fatty acid salt) is used in a greater amount, which seems to ensure the shape stability and increase the coatability onto substrates. The studies by the present inventors also revealed that use of a greater amount of the gelling agent on the contrary leads to decrease in adhesiveness (initial adhesiveness).

The present invention has been accomplished under these circumstances, and an object thereof is to provide a solid adhesive improved in initial adhesiveness while keeping favorable coatability onto substrates, and a liquid material composition for producing the solid adhesive.

### SUMMARY OF THE INVENTION

The solid adhesive according to the present invention, which accomplished the object, contains a water-soluble adhesive polymer and a polymer component derived from an aqueous polymer emulsion as the components, wherein the amount of the solid content of aqueous polymer emulsion is 0.01 to 30 mass %, with respect to the total amount of the water-soluble adhesive polymer and the solid content of the aqueous polymer emulsion.

### DESCRIPTION OF THE PREFERRED EMBODIMENTS OF THE INVENTION

The present inventors have found that by blending an aqueous polymer emulsion in a particular amount to a solid adhesive mainly containing a water-soluble adhesive polymer as the component, it is possible to improve the initial adhesiveness while keeping the favorable coatability onto substrates of the resulting adhesives. Hereinafter, features of the solid adhesive according to the present invention will be described in detail.

The solid adhesive has a water-soluble adhesive polymer as the main adhesive component. Polymer particles contained in an aqueous polymer emulsion, another component of the solid adhesive, may also contribute as the adhesive components, but if polymers in the aqueous polymer emulsion are the main adhesive components, the resulting solid adhesives tend to soften and exhibit decrease in shape stability, consequently resulting in for example decrease in coatability onto substrates and difficulty in use as adhesive stick. In such a case, a gelling agent as will be described below should be added in a greater amount for prevention of softening of the solid adhesive, which unavoidably causes decrease in adhesiveness.

Therefore, the solid adhesive according to the present invention has a water-soluble adhesive polymer as the primary component, and thus the amount of water-soluble adhesive polymer should be larger than the amount of solid content of aqueous polymer emulsion (equivalent practically to the amount of polymer particles) in the solid adhesive. Specifically, the content of the solid content of the aqueous polymer emulsion is 0.01 mass % or more and 30 mass % or less , with respect to the total amount of the water-soluble adhesive polymer and the solid content of aqueous polymer emulsion.

In the present invention, the solid content of aqueous polymer emulsion mean nonvolatile content after the aqueous polymer emulsion is dried under atmospheric pressure at 110° C. for 2 hours.

If the amount of solid content of aqueous polymer emulsion is beyond the range above, the hardness of the resulting solid adhesives tends to decrease as described. above, and also the coatability thereof onto substrates decreases. Use of a gelling agent in a greater amount to avoid this problem may lead to decrease in initial adhesiveness. The solid adhesives according to the present invention are obtained, for example, by mixing and heating raw materials into a viscous liquid, filling the liquid into a container (e.g., lipstick-shaped container), and allowing the liquid to cool and solidify. If the amount of solid content of aqueous polymer emulsion is beyond the range above, there may arise problems of increase of the viscosity of the liquid before filled into the container, and thus elongated periods of withdrawing the liquid from the container and filling the liquid into a lipstick-shaped container having a relatively small diameter of 1 to several cm. In addition, if the amount of solid content of the aqueous polymer emulsion is beyond the range above, there may also arise a problem in appearance, i.e., significant coloring of the solid adhesive.

On the other hand, an amount of solid content of the aqueous polymer emulsion below the range above may not ensure the advantageous effect of using the aqueous polymer emulsion. Thus, the amount of solid content of the aqueous polymer emulsion is preferably 0.1 mass % or more, more preferably 0.5 mass % or more and preferably 25 mass % or less, more preferably 20 mass % or less, with respect to the total amount of the water-soluble adhesive polymer and the solid content of aqueous polymer emulsion.

Examples of the water-soluble adhesive polymers include polymers produced by polymerizing monomer components containing an N-vinyllactam as the essential component; polyvinylalcohol and vinylalcohol copolymers; polyurethane and urethane copolymers; polyacrylic acid and acrylic acid copolymers, and the salts thereof; modified polysaccharides such as hydrokyethylstarch, hydroxypropylstarch, hydroxyethylcellulose, and carboxymethylcellulose; and the like. These polymers may be used alone or in combination of two or more polymers.

Among them, preferable from the viewpoint of ensuring favorable adhesiveness and sufficient shape stability even when the gelling agent described below is used in a smaller amount are polymers obtained by polymerizing a monomer component having an N-vinyllactam as the essential component, polyvinylalcohol and the copolymers thereof (in particular, polyvinylalcohol), and modified polysaccharides; and particular preferable are polymers obtained by polymerizing a monomer component having an N-vinyllactam as the essential component.

Typical examples of the N-vinyllactams which may be used for production of the polymers obtained by polymerizing a monomer component having an N-vinyllactams as the essential component include N-vinylpyrrolidone, N-vinyl-5-methyl-2-pyrrolidone, N-vinyl-2-piperidone, N-vinyl-6-methyl-2-piperidone, N-vinyl-ε-caprolactam, N-vinyl-7-methyl-ε-caprolactam, and the like, and these lactams may be used alone or in combination of two or more. N-vinylpyrrolidone is most preferable, from the viewpoints of adhesiveness, availability, and the like.

Monomers usable for producing the water-soluble adhesive polymers include, in addition to N-vinyllactams, (meth)acrylic alkyl esters such as methyl (meth)acrylate, ethyl (meth)acrylate, butyl (meth)acrylate, 2-ethylhexyl (meth)acrylate, stearyl (meth)acrylate and the like; (meth)acrylic acid or the salts thereof; amino group-containing monomers such as dimethylaminoethyl (meth)acrylate, dimethylaminopropyl (meth)acrylate, and the like; (meta)acrylonitrile; amide group-containing monomers such as (meta)acrylamide, N-methylol acrylamide, vinyl acetamide, vinyl formamide, and the like; vinyl acetate; styrene; vinylethers such as methylvinylether, ethylvinylether, butylvinylether, isobutylvinylether, and the like; α-olefins having 2 to 30 carbons; and the like, and these monomers may be used alone of in combination of two or more. However, these monomers except N-vinyllactams are preferably contained in an amount of 50 mass % or less with respect to 100 mass % of all monomer components. An amount of larger than 50 mass % may lead to decrease of the water-solubility and excellent adhesiveness of the polymers derived from N-vinyllactams.

Accordingly, among the polymers obtained by polymerizing monomer components having an N-vinyllactam as the essential component, polyvinylpyrrolidone or vinylpyrrolidone copolymers are more preferable, and polyvinylpyrrolidone is most preferable.

K value of the polymer obtained by polymerizing monomer components containing an N-vinyllactam as the essential component is calculated according to the following Formula, using a relative viscosity (25° C.) as determined by a capillary viscometer, using an aqueous solution thereof at a concentration of 1% by mass. As polymers having a larger K value provide the solid adhesives with a higher adhesive strength, the K value is preferably 50 or more, more preferably 70 or more, and still more preferably 80 or more.

$$\begin{matrix}K = \frac{1.5 log {η}_{rel} - 1}{0.15 + 0.003 c} + \frac{\sqrt{300 c log {η}_{rel} + {( c + 1.5 c log {η}_{rel} )}^{2}}}{0.15 c + 0.003 {c}^{2}} \\ {η}_{rel} \text{:} relative viscosity of polymer aqueous solution to water \\ c \text{:} concentration of the polymer in polymer aqueous solution ( mass \% )\end{matrix} \qquad [ Formula 1 ]$$

With respect to water-soluble adhesive polymers (not limited to the polymers obtained by polymerizing monomer components containing an N-vinyllactam as the essential component), a larger viscosity, which is determined at 25° C. by a Model B viscometer (spindle No.2) using an aqueous solution at a concentration of 10% by mass, leads to increase in the adhesive strength of resulting solid adhesives, and thus the viscosity is preferably 30 mPa·s or more, more preferably 70 mPa·s or more, and still more preferably 100 mPa·s or more.

Water-soluble adhesive polymers (in particular, polymers obtained by polymerizing monomer components containing an N-vinyllactam as the essential component) are generally high-priced, and occupy the major portion of the raw material cost of solid adhesives. The present invention allows use of cheaper aqueous polymer emulsion for improving the adhesiveness, and thus has an advantage that it is possible to reduce the amount of expensive water-soluble adhesive polymer used and consequently the cost of solid adhesives, for obtaining an adhesiveness at the same level of that of conventional solid adhesives.

The aqueous polymer emulsions used in the present invention are emulsions of polymer particles uniformly dispersed in a medium containing water. The aqueous polymer emulsion preferably has a minimum filming temperature (MFT) of 30° C. or less. Aqueous polymer emulsions having an MFT beyond the upper limit value may cause decrease of the adhesiveness of resulting solid adhesives at normal temperature. The MFT of the aqueous polymer emulsion is more preferably 25° C. or less, and still more preferably 20° C. or less. The MFT is a value determined by the following measuring method. An aqueous polymer emulsion is coated by using an applicator having a gap of 0.2 mm onto a glass plate placed on a thermal gradient analyzer, and the temperature at which a crack is generated in the coated film is measured to determine the MFT. That is the lowest temperature at which a continuous film having no cracks is formed.

For example, an aqueous polymer emulsion having an MFT of 30° C. or less may be produced, according to a rough standard, by using a polymer particle having a glass transition temperature (Tg) of 40° C. or less. The MFT of an aqueous polymer emulsion is empirically known to be about 10° C. lower than the Tg (° C.) of the polymer particle used. The Tg (K) of the polymer particles used in emulsions can be calculated easily based on the Tg value (K) of each homopolymer described in “POLYMER HANDBOOK, 3rd Ed.” (published by John Wiley & Sons, Inc.), or determined by using a differential scanning calorimeter (DSC) or a thermomechanical analyzer (TMA). Even when a polymer particle having a high Tg is used, it is possible to prepare an aqueous polymer emulsion having an MFT lower than the upper limit value above, by adjusting the solution using a plasticizer described below.

The resin (polymer particle) for the aqueous polymer emulsion is not particularly limited, if the resin has been used in the adhesive field. The aqueous polymer emulsions according to the present invention include polymer emulsions containing as the principal component a particle of one of the polymers including: vinyl acetate polymers such as polyvinyl acetate and vinyl acetate copolymers; acrylic polymers such as poly(meth)acrylic ester and acrylic ester-methacrylic ester copolymers; urethane polymers such as polyurethane; and the like. Alternatively, an alkali-soluble emulsion containing a (meth)acrylic ester-(meth)acrylic acid copolymer as the principal component of polymer particle may also be used. These aqueous polymer emulsions may be used alone or in combination of two or more. Among them, emulsions based on vinyl acetate polymers are preferable, as they provide solid adhesives superior in adhesiveness to paper, the major substrate of the solid adhesive according to the present invention.

The vinyl acetate polymers include polyvinyl acetate (homopolymer of vinyl acetate) and copolymers of vinyl acetate and other monomers. Examples of the other monomers copolymerizable with vinyl acetate include: olefins such as ethylene and the like; (meth)acrylic alkyl esters such as ethyl (meth)acrylate, butyl (meth)acrylate, isobutyl (meth)acrylate, t-butyl (meth)acrylate, 2-ethylhexyl (meth)acrylate, and the like; vinyl esters excluding vinyl acetate such as vinyl propionate, vinyl caprylate, vinyl caproate, vinyl versatate, and the like; maleic esters such as diethyl maleate, dibutyl maleate, dioctyl maleate, 2-ethylhexyl maleate, and the like; fumalate esters such as diethyl fumalate, dibutyl fumalate, dioctyl fumalate, and 2-ethylhexyl fumalate; and the like. These monomers may be used alone or in combination of two or more.

Among the vinyl acetate polymers obtained by using the monomer above, polyvinyl acetate is preferable, as the polymer provides solid adhesives superior in the adhesiveness to paper, the major substrate of the solid adhesive according to the present invention.

The emulsions of the vinyl acetate polymers above may additionally contain a publicly known emulsifier, protection colloid, or plasticizer (dibutyl phthalate, dioctyl phthalate, or the like).

The aqueous polymer emulsion above is produced by any of publicly known processes. Such processes include, for example, those by emulsion-polymerizing a monomer in an aqueous system and by dispersing (emulsifying) in a medium containing water the aforementioned resin separately polymerized. The solid content of the aqueous polymer emulsions is commonly 20 to 70% by mass.

The particle diameter of the polymer particles in aqueous polymer emulsions is not particularly limited, if the advantageous effects of the present invention are not impaired, but the average diameter is preferably, for example, 0.001 to 10 μm.

The solid adhesive according to the present invention contains a gelling agent as the component for ensuring its shape stability. The gelling agent is not particularly limited, and any one of publicly known gelling agents hitherto commonly used for solid adhesives may be used as the gelling agent. Examples thereof include metal or ammonium salts of fatty acids having 8 to 36 carbons such as laurate salts, myristate salts, palmitate salts, stearate salts, ricinolate salts; condensates of sugar alcohols having 4 or more carbons and aromatic aldehydes such as sorbit-benzaldehyde condensates, and xylit-benzaldehyde condensates. Alkali metal or ammonium salts of a fatty acid having 8 to 36 carbons are preferably, and alkali metal salts are more preferable. The alkali metal for the metal salts of fatty acid having 8 to 36 carbons is commonly Na, K, or the like.

The solid adhesives according to the present invention, although excellent in coatability onto substrates and initial adhesiveness, may sometimes provide products significantly colored. Coloration of products not only decreases the commercial value of solid adhesives, but also makes them unsuitable for use depending on the kind of substrates and damages the appearance of the substrates after coating, often restricting the range of applications.

After studies on the coloring above, the present inventors have found that the coloring of solid adhesives by the heat during production becomes more significant if the solid adhesives contain a water-soluble adhesive polymer and a polymer component derived from an aqueous polymer emulsion. However, the polymer component derived from aqueous polymer emulsion is imperative constituents for improving the initial adhesiveness of solid adhesives. Further studies revealed that addition of an inorganic reducing substance as a constituent to the solid adhesive containing a water-soluble adhesive polymer and a polymer component derived from aqueous polymer emulsion allows prevention of coloring while preserving the characteristics of solid adhesives such as the coatability onto substrates and initial adhesiveness. Accordingly, the solid adhesive according to the present invention preferably contains additionally an inorganic reducing substance as the constituent.

Inorganic reducing substances are particularly more preferable than organic reducing substances for the solid adhesive according to the present invention, because organic reducing substances cannot provide a sufficiently high anti-coloring effect, instead they can even accelerate coloring of solid adhesives by the heat generated during production.

For example, a sulfite salt such as sodium sulfite, potassium sulfite, sodium bisulfite, sodium hyposulfite, calcium sulfite, sulfur dioxide, sodium thiosulfate, or the like is preferably used as the inorganic reducing substance. Among them, sulfite salts are preferable as they are superior in anti-coloring effect and also in safety. Sodium sulfite is more preferable.

The amount of the inorganic reducing substance is preferably 0.001 part, more preferably 0.01 part or more by mass, with respect to 100 parts by mass of the total amount of the water-soluble adhesive polymer and the solid content of aqueous polymer emulsion. If the amount of the inorganic reducing substance mixed is larger than the lower limit value, the advantageous effect thereof in suppressing coloring of solid adhesives becomes more effective.

The upper limit of the amount of the inorganic reducing substance is not particularly limited, but preferably 40 parts or less, more preferably 20 parts or less by mass, with respect to 100 parts by weight of the total amount of the water-soluble adhesive polymer and the solid content of aqueous polymer emulsion. The solid adhesives according to the present invention are produced, for example, by mixing and heating raw materials into a viscous liquid, filling the liquid into a container (e.g., lipstick-shaped), and allowing the liquid to cool and solidify. When the amount of the inorganic reducing substance is beyond the upper limit value, the viscosity of the liquid increases before it is filled into the container, leading to elongation of the period required for filling the liquid into a lipstick-shaped container having a relatively minor diameter of 1 to several cm.

The degree of coloring of solid adhesives may be evaluated by using b value obtained by determining Lab color difference (color difference according to the formula for CIE Lab color difference specified in JIS Z8730) by means of a spectroscopic calorimeter. A larger b value indicates that the solid adhesive is more deeply colored in yellow, while a b value of not more than 3.5 indicates that the solid adhesives are white in the allowable range.

For production of solid adhesives, a water-soluble adhesive polymer, a gelling agent, and an aqueous polymer emulsion (additionally, an inorganic reducing substance as needed) are dissolved in an aqueous solvent, and the resulting solution is filled into a container for the solid adhesive composition. Water is preferable as the aqueous solvent, but the aqueous solvent may also include an alcohol such as ethanol, isopropyl alcohol, or the like; a ketone such as methylethylketone or the like; or an ester such as ethyl acetate or the like. The total amount of the aqueous solvent above may be the medium (medium containing water) contained in the aforementioned aqueous polymer emulsion.

A polyvalent alcohol is preferably added as a solubilizing aid for dissolving the gelling agent in the aqueous solvent and also as a wetting agent and a plasticizer. Examples thereof include bivalent alcohols such as ethylene glycol, propylene glycol, diethylene glycol, triethylene glycol, tetramethylene glycol; and trivalent or higher alcohols such as glycerin, trimethyrollpropane, pentaerythritol, and the like. Alternatively, cyclic alcohols such as ketoses (hexulose, heptulose, and the like), aldonic acid, aldaric acid, deoxy sugar, inositol sugar, and the like may also be used.

The amount of the gelling agent above in the solid adhesive according to the present invention is recommended to be preferably 10 parts or more, more preferably 15 parts or more and preferably 80 parts or less, more preferably 65 parts or less by mass, with respect to 100 parts by mass of the total amount of the water-soluble adhesive polymer and the solid content of aqueous polymer emulsion. If the amount of gelling agent is below the range above, the shape stability of resulting solid adhesives tends to decrease and thus causes the problems above. On the other hand, an amount of gelling agent over the range above sometimes leads to decrease in the initial adhesiveness of resulting solid adhesives.

In addition, the amount of the aqueous solvent in solid adhesives is preferably 100 parts or more, more preferably 150 parts or more and preferably 500 parts or less, more preferably 400 parts or less by mass, with respect to 100 parts by mass of the total amount of the water-soluble adhesive polymer and the solid content of aqueous polymer emulsion. If one of the organic solvent exemplified above is used in addition to water in the aqueous solvent, the amount of the organic solvent is preferably 10 mass % or less, and more preferably 5 mass % or less with respect to 100 mass % of the aqueous solvent. Of course, it is also preferable that the total amount of the aqueous solvent is water.

Further, if the above polyvalent alcohol is used, the amount thereof is preferably 5 parts or more, more preferably 10 parts or more and preferably 150 parts or less, more preferably 100 parts or less by mass, with respect to 100 parts by mass of the total amount of the water-soluble adhesive polymer and the solid content of aqueous polymer emulsion.

Any other publicly known additive may also be added to the solid adhesive according to the present invention composition. Examples of these additives include: water-soluble polymers such as polyalkylene glycol, polyalkylene oxide, polyalkylene imine, and the like; oils such as flaxseed oil, ricin oil, castor oil, soy bean oil, palm oil, tall oil, fish oil, oleic acid, linolic acid, linoleic acid, and the like; surfactants such as polyhydroxyalkylene ether, polyhydroxyalkylene fatty esters, polyhydroxyalkylene sorbitan (mono-, di-, and tri-)fatty esters, (poly)glycerin (mono-, di-, and tri-)fatty esters, sorbitan (mono-, di-, and tri-)stearate, and the like; lubricants such as liquid paraffin and the like; inorganic fillers such as silica, alumina, titanium dioxide, barium oxide, zinc oxide, talc, bentonite, and the like; sugars such as sucrose, sorbitol, and the like; dextrins such as dextrins and cyclodextrins; and the like. These additives may be used in a suitable amount as needed. In addition, a flavoring agent, fluorescent brightener, antibacterial agent, antiseptic substance, coloring agent, or the like may also be blended. For example, an antibacterial agent is preferably added to the solid adhesive in an amount of about 0.01 to 0.1% by mass.

A typical method of producing solid adhesives is, for example, as follows: After a water-soluble adhesive polymer and an aqueous polymer emulsion (additionally, an inorganic reducing substance as needed) are mixed in an aqueous solvent (preferably, water), the resulting mixture is heated and stirred, to give a homogeneous dispersion (i.e., a liquid material composition for solid adhesive according to the present invention), and further, a gelling agent and additionally a polyvalent alcohol as needed are mixed thereto and dissolved into a homogeneous solution, and further various other additives are added thereto, to give a viscous liquid. The liquid is then filled into a container (for example, lipstick-shaped or the like) and allowed to cool and solidify, to give a solid adhesive. Here, the order of addition of respective ingredients is not particularly limited, and the respective ingredients may be added and mixed in the order different form that described above. It goes without saying that it is not necessary to use an aqueous solvent additionally, if the total amount of the aqueous solvent is the medium derived from the aqueous polymer emulsion.

Alternatively, it is also possible that a liquid material composition for solid adhesive is prepared in advance; then, for example, a water-soluble adhesive polymer, a gelling agent, a polyvalent alcohol, and/or various additives are added to and mixed in the liquid material composition to give a viscous liquid; and the liquid is then converted to a solid adhesive according to the method described above. In the liquid material compositions for solid adhesives prepared in this manner, the content of the water-soluble adhesive polymer (preferably a polymer obtained by polymerizing monomer components having an N-vinyllactam as the essential component) is 1 mass % or more, preferably 5 mass % or more and 40 mass % or less, preferably 30 mass % or less, and the content of the solid content of aqueous polymer emulsion is 0.01 mass % or more, preferably 0.05 mass % or more, more preferably 0.1 mass % or more and 50 mass % or less, preferably 40 mass % or less, more preferably 30 mass % or less. Use of the liquid material composition above allows easier production of solid adhesives. If the amounts both of the water-soluble adhesive polymer and the solid content of aqueous polymer emulsion exceed the range above, the viscosity of the liquid material composition becomes too large, making it more difficult to handle, while the amounts become lower the range above, it becomes more difficult to adjust the amount of each component in production of the solid adhesives according to the present invention.

The favorable range of the amount of each component in liquid material compositions is slightly different from the favorable range of the amount of each component in solid adhesive. As described above, it is because the solid adhesives may be possibly produced by additionally adding a water-soluble adhesive polymer to the liquid material composition.

If an inorganic reducing substance is contained in the liquid material composition for solid adhesives, the amount of the inorganic reducing substance mixed is recommended to be preferably 0.001 part or more, more preferably 0.01 part or more and preferably 40 parts or less, more preferably 20 parts or less by mass, with respect to 100 parts by weight of the total amount of the watersoluble adhesive polymer and the solid content of aqueous polymer emulsion. An amount of the inorganic reducing substance less than the range above may lead to decrease in the advantageous effect of suppressing color development of solid adhesives. On the other hand, addition of the inorganic reducing substance in an amount larger than the range above may result in increase in the viscosity of the liquid material composition and make it more difficult to handle.

The inorganic reducing substance has, in addition to the effect of suppressing color development of solid adhesives, an advantageous effect of suppressing decrease in viscosity of the liquid material composition for solid adhesive during storage. The decrease in viscosity of the liquid material composition leads to decrease in the adhesive strength of solid adhesive produced by using the same. However, addition of the inorganic reducing substance can prevent the problems above and allows production of solid adhesives having a favorable adhesive strength.

Further, blending of the inorganic reducing substance previously to the liquid material composition can also prevent the color development of liquid material compositions during storage. In this manner, the inorganic reducing substance is also effective in ensuring the stability of the liquid material compositions during storage.

Favorable substrates onto which the solid adhesive according to the present invention can be applied include publicly known papers such as Japanese paper, synthetic paper, wood-free paper, wood-containing paper, art paper, coated paper, cast coated paper, foil paper, Kraft paper, impregnated paper, deposited paper, and the like; films (including sheets) of polyesters such as polyethylene terephthalate, polybutylene terephthalate, and the like; woven and unwoven fabrics and the like made from cotton, polyester, or nylon fiber or the like; various threads; metal foils such as aluminum foil and copper foil; and the like.

### INDUSTRIAL APPLICABILITY

In the present invention, a solid adhesive which mainly contains a water-soluble adhesive polymer as the main component is improved in initial adhesiveness while preserving its favorable coatability (shape stability) onto substrates, by blending an aqueous polymer emulsion in a particular amount thereto.

### EXAMPLE

Hereinafter, the present invention will be described in detail with reference to EXAMPLES. However, it should be understood that the present invention is not limited by the following EXAMPLES by any means and any modifications within the objects described above or below are also included in the technical scope of the present invention. The “part” and “%” used in the following EXAMPLES are values by mass, unless otherwise noted. Further, the evaluation methods used in these EXAMPLES are as follows:

(1) Adhesion Time

The following experiment was conducted under the environment of a temperature of 25° C. and a relative humidity of 60% at ambient atmosphere. A plain copying paper (PPC paper) was cut into pieces of 3 cm×6 cm in size and used as test papers. A solid adhesive was coated on the half portion of one face of the test paper and the adhesive portion was immediately attached to another test paper. After a predetermined period from the time of attachment, non-adhesive portions of the test papers bonded were pulled and peeled in the opposite directions periodically. The period from the time of attaching test papers to the time when test papers cannot be peeled any longer without broken was designated as the adhesion time. A shorter adhesion time indicates that the solid adhesive exerts its adhesive strength in a shorter period of time or has a higher initial adhesiveness.

(2) Coatability

Under the environment of a temperature of 25° C. and a relative humidity of 60% at ambient atmosphere, a cylindrical solid adhesive having a diameter of 23 mm was place on a plain copying paper under a load of 1 kg atop the solid adhesive, and the copying paper was pulled horizontally at a speed of 10 mm/sec. The extent of deformation of the solid adhesive was evaluated by visual observation. The evaluation criteria are as follows:

◯: No deformation

Δ: Slight deformation

X: Large deformation, unsuitable for coating

(3) Brightness (b Value)

Lab color differences (color difference determined by the formula for CIE Lab color difference, specified in JIS Z 8730) of the solid adhesives obtained by experiments below were determined by using a spectroscopic calorimeter (SE-2000 manufactured by Nippon Denshoku Co. Ltd.). The brightness values shown in TABLES 3 to 4 were determined by using the b value.

(4) Viscosity

A 100-ml beaker containing 70 g of a liquid material composition for solid adhesive was placed in a thermostat at 25° C. for 3 hours. The viscosity of the liquid composition was determined by using a Model B viscometer (spindle No.3) at a revolution speed of 3 rpm.

### Example 1

The water-soluble adhesive polymer used in this EXAMPLE was polyvinylpyrrolidone (“K85” manufactured by Nippon Shokubai) or hydroxypropylstarch (“Sorbitose HDF” manufactured by Matsutani Chemical Industry). The K value of this polyvinylpyrrolidone determined according to the method above is 83; the viscosity of the 10% aqueous solution determined by the measurement method above is 290 mPa·s; and the weight average molecular weight determined by gel-permeation chromatography (as polystyrene) is about 1,000,000. The viscosity of the 10% aqueous solution of the hydroxypropylstarch determined according to the measurement method above is 300 mPa·s.

Further, the aqueous polymer emulsion used in this EXAMPLE is a polyvinyl acetate emulsion having a solid content of 50% (“Vinybran 1107L”, manufactured by Nisshin Chemical Industry). The MFT of the polyvinyl acetate emulsion determined according to the measurement method above is 2° C.

### Example 1-1

Into a flask equipped with a reflux condenser and a stirrer, 59.0 parts of water and 1.0 part of a polyvinyl acetate emulsion were added, and the mixture was heated gradually to a temperature of 80° C. while stirred. Subsequently, 26.0 parts of polyvinylpyrrolidone was added in portions so that the polymer is dissolved without coagulation, to give a liquid material composition. Then, 7.0 parts of glycerin and 7.0 parts of sodium stearate (gelling agent) were added, and the resulting mixture was stirred for 24 hours to give a viscous white liquid. After heated to 90° C., the liquid was poured into a lipstick-shaped container (internal diameter: 23 mm, length: 80 mm) and allowed to cool and solidify, giving a solid adhesive. The composition and evaluation results of this solid adhesive are summarized in TABLE 1.

### EXAMPLES 1-2 to 1-9

Solid adhesives were prepared in the similar manner to EXAMPLE 1-1, except that respective raw materials were added in the blending compositions shown in TABLE 1. The evaluation results of these solid adhesives are summarized in TABLE 1. The solid adhesives of EXAMPLES 1-6 and 1-7 were prepared without using the polyvinyl acetate emulsion above, and thus are equivalent to conventional polyvinylpyrrolidone-based solid adhesives.

TABLE 1

| EXAMPLE No. | | 1-1 | 1-2 | 1-3 | 1-4 | 1-5 | 1-6 | 1-7 | 1-8 | 1-9 |
|---|---|---|---|---|---|---|---|---|---|---|
| Blending | Polyvinylpyrrolidone | 26 | 23.4 | 23.4 | 23.4 | 23.4 | 26.0 | 23.4 | 23.4 | 13.0 |
| composition | Polyvinyl acetate emulsion | 0.5 | 0.5 | 2.0 | 4.0 | 7.0 | 0 | 0 | 13.0 | 7.0 |
| (part) | (solid content) | | | | | | | | | |
| | Sodium stearate | 7.0 | 7.0 | 7.0 | 7.0 | 7.0 | 7.0 | 7.0 | 7.0 | 13.0 |
| | Glycerin | 7.0 | 7.0 | 7.0 | 7.0 | 7.0 | 7.0 | 7.0 | 7.0 | 8.0 |
| | Water | 59.5 | 62.1 | 60.6 | 58.6 | 55.6 | 60.0 | 62.6 | 55.6 | 56.0 |
| Solid content derived from polyvinyl | | 1.9 | 2.1 | 7.9 | 14.6 | 22.8 | 0 | 0 | 35.7 | 35.0 |
| acetate emulsion (part) | | | | | | | | | | |
| Characteristics | Adhesion time (second) | 135 | 195 | 165 | 165 | 150 | 210 | 300 | — | >1800 |
| | | ⊚ | ◯ | ◯ | ◯ | ◯ | Δ | X | | X |
| | Coatability | ◯ | ◯ | ◯ | ◯ | ◯ | ◯ | ◯ | X | ◯ |
| | Overall rating | ◯ | ◯ | ◯ | ◯ | ◯ | Δ | X | X | X |

The “Polyvinyl acetate emulsion (solid matter)” in the rows of blending composition of TABLE 1 indicates the content of solid content in each polyvinyl acetate emulsion, while “water”, the total amount of water contained in each polyvinyl acetate emulsion and of water used separately. In addition, the value in the row of “Solid content derived from polyvinyl acetate emulsion” is a concentration with respect to the total amount in solid adhesive of polyvinylpyrrolidone and the solid content derived from polyvinyl acetate emulsion.

The evaluation results, “⊚, ◯, Δ, and X” in the row of “Adhesion time” in TABLE 1 were determined by comparison of the adhesion time of each solid adhesive with that of the solid adhesive of EXAMPLE 1-6 equivalent to conventional solid adhesives, which was designated as (Δ). That is, solid adhesives having an adhesion time significantly shorter than that of the solid adhesive of EXAMPLE 1-6 were designated as “⊚”; those having an adhesion time somewhat shorter, “◯”; and those having an adhesion time longer, “X”. Further, the overall rating in TABLE 1 was determined by comparing the characteristics (adhesion time, coatability) of each solid adhesive with those of the solid adhesive of EXAMPLE 1-6 equivalent to conventional solid adhesives, which was designated as (Δ). That is, if at least one of the characteristics above is better than those of the solid adhesive of EXAMPLE 1-6 and another characteristic is equivalent to that of EXAMPLE 1-6, the overall rating was designated as “◯”; if at least one of the characteristics above is inferior to those of the solid adhesive of EXAMPLE 1-6, “x”.

As apparent from TABLE 1, the solid adhesives of EXAMPLES 1-1 to 1-5 have a solid content of the polyvinyl acetate emulsion in a favorable range and are excellent both in initial adhesiveness and coatability. In particular, the solid adhesive of EXAMPLE 1-1 has an extremely high initial adhesiveness, while those of EXAMPLES 1-2 to 1-5, which were prepared with decreasing amounts of pricey polyvinylpyrrolidone used, still retain an adhesiveness superior to that of the conventional adhesive (EXAMPLE 1-6), achieving reduction in the cost of solid adhesives. Apparently, the adhesion time of the solid adhesive of EXAMPLE 1-2 (195 seconds), for example, is shorter only by a small difference from that of the solid adhesive of EXAMPLE 1-6 (210 seconds). However, assuming a practical use mode, for example, adhesion of papers by using a adhesive stick (solid adhesive), it is self-apparent that the cut down of the period required for adhesion to be effective by 15 seconds improves the efficiency of the adhesive drastically. For that reason, the solid adhesive of EXAMPLE 1-2 may be judge to have a higher initial adhesiveness than the solid adhesive of EXAMPLE 1-6.

In contrast, the solid adhesive of EXAMPLE 1-7 prepared in the similar manner to EXAMPLES 1-2 to 1-5 by using a smaller amount of polyvinylpyrrolidone is inferior in initial adhesiveness, as it was prepared without use of the polyvinyl acetate emulsion.

Further, the solid adhesive of EXAMPLES 1-8 prepared by using an excessive amount of polyvinyl acetate emulsion is reduced in shape stability and particularly in coatability. Therefore, the adhesion time thereof was not performed.

EXAMPLE 1-9 is an example of improving the hardness (i.e., shape stability) of solid adhesive by increasing the use amount of the gelling agent with respect to the amount of water-soluble adhesive polymer, in order to overcome the decrease in coatability of the solid adhesive of EXAMPLE 1-8. The solid adhesive was extremely inferior in initial adhesiveness, although the coatability and mold-filling property were fairly good.

### Example 1-10

A solid adhesive was prepared in the similar manner to EXAMPLE 1-1,except that a hydroxypropylstarch was used as the water-soluble adhesive polymer. The evaluation results of this solid adhesive are shown in TABLE 2.

### Example 1-11

A solid adhesive was prepared in the similar manner to EXAMPLE 1-10,except that the polyvinyl acetate emulsion was not used. The solid adhesive of EXAMPLE 1-11 is equivalent to a conventional hydroxypropylstarch-based solid adhesive, as it was prepared without the use of the polyvinyl acetate emulsion. The evaluation results of this solid adhesive are shown in TABLE 2.

TABLE 2

| | | |
|---|---|---|
| EXAMPLE No. | 1-10 | 1-11 |

| | | | |
|---|---|---|---|
| Blending | Hydroxypropylstarch | 26.0 | 26.0 |
| composition | Polyvinyl acetate | 0.5 | — |
| (part) | emulsion (solid content) | | |
| | Sodium stearate | 7.0 | 7.0 |
| | Glycerin | 7.0 | 7.0 |
| | Water | 59.5 | 60.0 |

| | | |
|---|---|---|
| Solid content derived from polyvinyl acetate | 1.9 | 0 |
| emulsion (part) | | |

| | | | |
|---|---|---|---|
| Characteristics | Adhesion time (second) | 300 | 360 |
| | | ⊚ | Δ |
| | Coatability | ∘ | ∘ |

The value of “Polyvinyl acetate emulsion (solid matter)” in the rows of blending composition in TABLE 2 indicates the solid content of polyvinyl acetate emulsion, while the value of “Water”, the total amount of water in the polyvinyl acetate emulsion and water separately used. The value in the row of “Solid content derived from polyvinyl acetate emulsion” indicates the number of parts relative to that of the sum of hydroxypropylstarch and solid content derived from polyvinyl acetate emulsion of solid adhesive.

In the row of “Adhesion time” in TABLE 2, “◯” indicates that the adhesion time is shortened compared to the adhesion time (Δ) of the solid adhesive of EXAMPLE 1-11, which is equivalent to conventional solid adhesives.

As apparent form TABLE 2, the solid adhesive of EXAMPLE 1-10 containing solid content of the polyvinyl acetate emulsion in a suitable amount is improved in initial adhesiveness without the sacrifice of coatability, compared to the solid adhesive of EXAMPLE 1-11 equivalent to conventional solid adhesives.

### Example2

The water-soluble adhesive polymer used in EXAMPLE 2 was polyvinylpyrrolidone (EXAMPLES 2-1 to 2-7: “K85” manufactured by Nippon Shokubai; K value: 85), and the aqueous polymer emulsion used was a polyvinyl acetate emulsion having a solid content of 50% (“Vinybran 1107L”, manufactured by Nisshin Chemical Industry).

### Example 2-1

A mixture of 54.6 parts of water and 8.0 parts of the polyvinyl acetate emulsion was placed in a flask equipped with a reflux condenser and a stirrer and heated gradually to 80° C. while stirring. Then, 23.4 parts of the polyvinylpyrrolidone described above was added in portions so that the polymer is dissolved without coagulation, and additionally 1.0 part of sodium sulfite was added, to give a liquid material composition. Subsequently, 6.0 parts of glycerin and 7.0 parts of sodium stearate (gelling agent) were added, and the resulting mixture was stirred for 24 hours, to give a viscous white liquid. The liquid was heated to 90° C., and then filled into a lipstick-shaped container (internal diameter: 23 mm, length: 80 mm) and then allowed to cool and solidify, to give a solid adhesive. The composition and the evaluation results of the solid adhesive are summarized in TABLE 3.

### Examples 2-2 to 2-5

Solid adhesives were prepared in the similar manner to EXAMPLE 2-1, except that respective raw materials were added in the blending composition shown in TABLE 3. The evaluation results of these solid adhesives are summarized in TABLE 3. The solid adhesives of EXAMPLES 2-1 and 2-2 contain an inorganic reducing substance, those of EXAMPLES 2-4 and 2-5, an organic reducing substance, while the solid adhesive of EXAMPLE 2-3 does not contain a reducing substance.

TABLE 3

| EXAMPLE No. | | 2-1 | 2-2 | 2-3 | 2-4 | 2-5 |
|---|---|---|---|---|---|---|
| Blending | Polyvinylpyrrolidone | 23.4 | 23.4 | 23.4 | 23.4 | 23.4 |
| composition | Sodium stearate | 7.0 | 7.0 | 7.0 | 7.0 | 7.0 |
| (part) | Glycerin | 6.0 | 6.0 | 7.0 | 6.0 | 6.0 |
| | Water | 58.6 | 58.6 | 58.6 | 58.6 | 58.6 |
| | Polyvinyl acetate | 4.0 | 4.0 | 4.0 | 4.0 | 4.0 |
| | emulsion (solid content) | | | | | |
| | Reducing agent | Na sulfite | Ca sulfite | — | Na Oxalate | Na |
| | | | | | | L-ascorbate |
| | | 1.0 | 1.0 | | 1.0 | 1.0 |

| | | | | | |
|---|---|---|---|---|---|
| Brightness (b value) | 0.7 | 2.5 | 5.0 | 5.0 | 14.9 |

The value of “Polyvinyl acetate emulsion (solid matter)” in the rows of blending composition of TABLE 3 indicates the content of the solid content in the polyvinyl acetate emulsion, while the value of “water”, the total amount of water contained in the polyvinyl acetate emulsion and water used separately.

As apparent from, TABLE 3, the brightness (b value) of the solid adhesives of EXAMPLES 2-1 and 2-2 which contain an inorganic reducing substance was smaller than that of the solid adhesive of EXAMPLE 2-3 which contains no reducing substance, indicating a significant anti-coloring effect of the inorganic reducing substance. In particular, the solid adhesive of EXAMPLE 2-1 containing sodium sulfite as the inorganic reducing substance has an extremely small b value (b value: 0.7), indicating an excellent anti-coloring effect exerted.

In contrast, the b values of solid adhesives of EXAMPLES 2-4 and 2-5, which contain an organic reducing substance, are about the same as (EXAMPLE 2-4) or larger (EXAMPLE 2-5) than that of the solid adhesive of EXAMPLE 2-3 containing no reducing substance equivalent, indicating that the organic reducing substances could not suppress but rather accelerate coloring. In particular, the solid adhesive of EXAMPLE 2-5 containing sodium L-ascorbate had a larger b value (b value: 14.9) and was significantly colored.

### Examples 2-6 and 2-7

Raw liquid compositions for solid adhesives were prepared in the similar manner to EXAMPLE 2-1, except that respective raw materials were added in the blending composition shown in TABLE 4. The liquid material compositions thus obtained were sealed in a glass sample tube under the air atmosphere and stored protected from. light at 60° C. for 3 weeks. The storage stability of the liquid material compositions during the period was evaluated. The storage stability was determined by comparing the degrees of brightness of the liquid material composition before and after storage. The evaluation results of these liquid material compositions are summarized in TABLE 4.

TABLE 4

| | | |
|---|---|---|
| EXAMPLE No. | 2-6 | 2-7 |

| | | | |
|---|---|---|---|
| Blending | Polyvinylpyrrolidone | 16.0 | 16.0 |
| composition | Polyvinyl acetate emulsion | 9.0 | 9.0 |
| (part) | (solid content) | | |
| | Water | 73.0 | 75.0 |
| | Sodium sulfite | 2.0 | — |
| Coloring (b | Initial | −0.2 | −0.3 |
| value) | 60° C. × 3 weeks later | 0.6 | 5.7 |
| Viscosity (mPa · s) | Initial | 22000 | 20560 |
| | 60° C. × 3 weeks later | 21640 | 5080 |

The liquid material composition of EXAMPLE 2-6 containing sodium sulfite as the inorganic reducing substance showed a smaller difference in brightness before and after storage and almost no decrease in viscosity even under the severe condition described above, indicating that the composition was excellent in storage stability. On the other hand, the liquid material composition of EXAMPLE 2-7 containing no sodium sulfite exhibited significant coloring and a drastic decrease in viscosity after storage under the condition above, indicating that the liquid material composition was not suitable for producing solid adhesives.

This application is based on Japanese Patent application No. 2003-148907 filed on May 27, 2003, and Japanese Patent application No. 2003-188412 filed on Jun. 30, 2003, the contents of which are hereby incorporated by reference.

What is claimed is:

1. A solid adhesive comprising a water-soluble adhesive polymer and a polymer component derived from an aqueous polymer emulsion, wherein a solid content of said aqueous polymer emulsion is contained in an amount of 0.01 to 30 mass % with respect to the total amount of said water-soluble adhesive polymer and said solid content of aqueous polymer emulsion.

2. The solid adhesive according to claim 1, further comprising an inorganic reducing substance.

3. The solid adhesive according to claim 1, wherein the minimum filming temperature of said aqueous polymer emulsion is 30° C. or less.

4. The solid adhesive according to claim 1, wherein said water-soluble adhesive polymer comprises a polymer produced by polymerizing monomer containing an N-vinyllactam as the essential component.

5. A liquid material composition for producing the solid adhesives according to claim 1, comprising a water-soluble adhesive polymer and a polymer component derived from an aqueous polymer emulsion.
